(19) United States
(12) Patent Application Publication
(10) Pub. No.: US 2012/0160281 A1
(43) Pub. Date: Jun. 28, 2012

(54) WASHING APPARATUS

(75) Inventors: Hideo Hashimoto, Uji-shi (JP); Yuuki Namikawa, Uji-shi (JP); Masahiro Hashimoto, Uji-shi (JP); Takahisa Fujii, Uji-shi (JP)

(73) Assignee: HAPPY CO., LTD., Uji-shi, Kyoto (JP)

(21) Appl. No.: 13/379,495

(22) PCT Filed: Jul. 20, 2011
(86) PCT No.: PCT/JP2011/066398

§ 371 Date: Dec. 20, 2011

(30) Foreign Application Priority Data
Jul. 27, 2010 (JP) 2010-168288

(51) Int. Cl. B08B 3/04

(52) U.S. Cl. 134/120; 134/119

(57) ABSTRACT

A washing apparatus is provided with a washing tub 2 whose rotating axis is in a horizontal direction or in a horizontally inclined direction, and has a concave and convex curve surface 22 installed on an inside wall surface of the washing tub 2 as well as has a baffle 25 protruding in the direction of the rotating axis installed. Then, by rotating the washing tub with a level of a cleaning liquid to be supplied to the washing tub 2 set to be higher than the rotating axis, a spurious non-gravity wash method is adopted in which damage to a washing article is small. In addition, by rotating the washing tub 2 with the level of the cleaning liquid to be supplied to the washing tub 2 set to be lower than the rotating axis, a beat wash method in which water saving effect is high is adopted.

### TECHNICAL FIELD

The present invention relates to a washing apparatus that washes washing articles. The present invention particularly relates to a washing apparatus that washes washing articles in a washing tub which is filled with a cleaning liquid including water, a petroleum solvent or an organic solvent and the like.

### BACKGROUND ART

As a conventional washing apparatus, such a washing apparatus becomes popular not only as is provided with a washing tub, wherein a rotating axis is formed in a vertical direction, but also as is provided with a washing tub, wherein the rotating axis is formed in a horizontal direction or in a direction to be inclined from the horizontal direction (to be referred as “a horizontally inclined direction” hereafter). Then, the washing apparatus being provided with a washing tub, in which the rotating axis is formed vertically, generates a rotating flow (a swirling water current) in the cleaning liquid inside the washing tub, by rotating a pulsator that is installed to the bottom of the washing tub. By a force of the rotating flow of the cleaning liquid that is generated, washing articles such as clothes and the like are rubbed each other, so that the washing articles are washed. (Hand-wash-like rubbing wash method) On the other hand, a washing apparatus that is provided with a washing tub (drum), wherein the rotating axis is formed in a horizontal direction or in a horizontally inclined direction, moves a washing article to the upper side of the washing tub with a baffle (blade-like portion) being protruded on the inside wall surface of the washing tub, by rotating the washing tub, and subsequently has the washing article drop by its own weight. When the washing article drops, the washing article is washed by an impact force that is caused by an impact against the inside wall surface of the washing tub. (Beat wash method)

A cleaning liquid that is used for washing by aforementioned washing apparatus is categorized into a water type of cleaning liquid such as water or a solvent in which a surface acting agent is mixed with water; and a non-water type of cleaning liquid such as a petroleum solvent or an organic type of solvent and the like. When the water type of cleaning liquid is used, contamination of water solubility that is attached to a washing article is washed off. However, depending on a clothing fabric or fiber of the washing article, the washing article is susceptible to hardening or damage, which worsens the condition of the washing article after washing. On the other hand, when the non-water type of cleaning liquid is used, it is possible to avoid a risk of having the washing article damaged in such a case as when the water type of cleaning liquid is used, but the contamination of water solubility cannot be completely eliminated and washed off.

For the above-mentioned inconvenient case, the present applicant proposes a washing method (See Patent Publication 1.) and a washing apparatus (See Patent Publication 2 and Patent Publication 3.). In Patent Publication 1, Patent Publication 2 and Patent Publication 3, the cleaning liquid fills the casing (water tub) which includes the washing tub (drum) having its central axis in the horizontal direction, and the washing tub is rotated. As the result, the washing article being contained inside the washing tub is made to float inside a cleaning liquid and is washed. In the washing apparatus described in Patent Publications 1, 2 and 3, the washing tub is rotated, wherein concaves and convexes are provided to the inside wall surface thereof continuously in a circumferential direction. Consequently, swirling water currents are generated for each concave and convex of the inside wall surface of the washing tub in the cleaning liquid on the side of the inside wall surface of the washing tub. By having the swirling water currents formed continuously along the inside wall surface of the washing tub, a large flow is generated along the rotation of the washing tub in the cleaning liquid inside the washing tub. Because the swirling water currents and the large flow that are generated in such a manner as mentioned above influence the washing article, the washing article is made to float and spreads inside the washing tub in such a manner as it drifts in the washing tub. Therefore, a contact surface of the washing article with the cleaning liquid is increased, and furthermore, a penetrating force of the cleaning liquid into the washing article is enhanced. As a result, washing effects of the cleaning liquid on contamination of the washing article are enhanced.

Like the washing apparatus of each of the above-mentioned Patent Publications, a pressure distribution is formed based on the rotation of the washing tub for the cleaning liquid that fills the casing, and thereby, washing is performed. As a result, the present applicant can avoid the washing article from being damaged and enhance the washing effects. In addition, the pressure distribution that is formed in the cleaning liquid influences behaviors of the washing article inside the cleaning liquid. Therefore, in order to achieve the washing effects sufficiently, it is necessary that the pressure distribution be formed effectively in the cleaning liquid filling the casing.

Then, the present applicant performed further verification for each construction of the aforementioned Patent Publications. As a result, as mentioned above, it was clarified that the pressure distribution is formed inside the cleaning liquid by rotation of a concave and convex surface that is provided to the inside wall surface of the washing tub continuously in a circumferential direction. Namely, in the washing tub, the concave and convex surface is formed along the rotating direction thereof. Therefore, when the washing tub rotates, the cleaning liquid inside the concave portions moves toward the direction of the rotation by the convex portions, but the cleaning liquid itself tries to remain and stay. And thereby, swirling water currents in a spiral form are generated inside the concave portions.

By having the swirling water currents in a spiral shape formed in each of the concave portions, the cleaning liquid that fills the casing flows in a form of an approximately concentric circle at a different flow rate along a radial direction of the washing tub. Consequently, a pressure distribution is formed in the radial direction of the washing tub. The pressure distribution that is formed in the radial direction of the washing tub makes the washing article float inside the washing tub. As a result, the washing article that floats and drifts inside the cleaning liquid is spread. And thereby, the washing effects are advanced and at the same time, the washing article can be prevented from being damaged. Hereafter, a washing method in the washing apparatus of each of the aforementioned Patent Applications is referred as “spurious zero-gravity wash method.”

### DOCUMENTS OF THE PRIOR ART

### Patent Publications

Patent Publication 1 JP-3841822
Patent Publication 2 JP-3863176
Patent Publication 3 Patent Application Laid Open as 2010-22645

### SUMMARY OF THE INVENTION

### Problem to be Solved by the Invention

The washing apparatus of each of the aforementioned Patent Publications uses a large volume of the cleaning liquid, compared to a general washing apparatus for family use because the washing tub thereof is filled with the cleaning liquid in such a manner as the washing tub completely soaks in the cleaning liquid filling the casing, or the like. Therefore, the washing apparatus of each of the aforementioned Patent Publications is less effective in the water-saving effect thereof, and is difficult to be applied as a washing apparatus that requires high water-saving effect such as a washing apparatus for family use, especially. Additionally, in recent years, various clothes have been developed that can be washed by a washing machine for family use. These clothes need not be washed by the washing apparatus of each of the aforementioned Patent Publications but can be washed well by the washing machine for family use. On the other hand, a drum-type washing machine that washes the clothes in accordance with the beat wash method has the following problems: Not only the clothing fabric of the clothes is damaged by washing, but also the clothes cannot be rinsed with a sufficient volume of water, so that all the detergent is not removed but remains on the clothes.

### Means for Solving Problem

In view of the above problem, the present invention has an object to propose a washing apparatus that can change over the washing method thereof, depending on the material of the article to be washed.

In order to achieve the above-mentioned purpose, a washing apparatus in accordance with the present invention is provided with a washing tub that rotates by a rotating axis which is inclined toward a horizontal direction from a vertical direction or is set to be horizontal and that has a washing article contained therein; a casing that covers the washing tub and is supplied with a cleaning liquid; a concave and convex curve surface that is provided on an inside wall surface of the washing tub and is formed in concave and convex in radial direction of the washing tub; wherein, at least one baffle is provided that is installed to protrude toward the radial direction of the washing tub from the inside wall surface of the washing tub; and that has a height thereof along the radial direction of the washing tub which is higher than a height of a convex portion of the concave and convex curve surface; and wherein, a washing method of a washing article can be selected from a first washing method, in which the washing article is washed by making the washing article float in a cleaning liquid to be supplied to the washing tub, and a second washing method, in which the washing article is washed by having the baffle agitate the washing article

### Effect of the Invention

In accordance with the present invention, by providing a baffle to the washing tub that has a concave and convex curve surface, it is possible to change over the washing method between the first washing method that employs the spurious zero-gravity wash method and the second washing method that employs the beat wash method, depending on an object to be washed. As a result, for the clothes that can be washed by employing the beat wash method, the second washing method is selected, which leads to reduction in a volume of the cleaning liquid to be used during washing, and thereby, water-saving effect is enhanced. On the other hand, for the clothes that are vulnerable to a damage being caused by washing that employs the beat wash method, the first washing method is selected, whereby it is possible to inhibit damages to the clothes during washing. Additionally, in rinsing, when the first washing method is employed, rinsing effect can be enhanced. Moreover, when dewatering is performed by the washing tub being supplied with slits, damages being caused to the clothes during dewatering can be inhibited because the washing tub is provided with a concave and convex curve surface.

### BRIEF DESCRIPTION OF DRAWINGS

FIG. 1 is a schematic perspective view that shows a construction of a washing apparatus in accordance with an embodiment of the present invention.

FIG. 2 is a schematic perspective view that shows a construction of a washing tub that is installed to inside of a casing of the washing apparatus shown in FIG. 1.

FIG. 3 is a schematic cross sectional view of a washing tub that is vertical to a rotating axis of the washing tub shown in FIG. 2.

FIG. 4 is a block diagram that shows an approximate construction of a piping system and a control system of a washing apparatus in accordance with the embodiment of the present invention.

FIG. 5 is a schematic cross sectional view that shows a construction of a first example of a baffle that is installed to the washing apparatus shown in FIG. 2.

FIG. 6 is a schematic cross sectional view that shows a construction of a second example of a baffle that is installed to the washing apparatus shown in FIG. 2.

FIG. 7 is a schematic cross sectional view that shows a construction of a third example of a baffle that is installed to the washing apparatus shown in FIG. 2.

### MODE FOR CARRYING OUT THE INVENTION

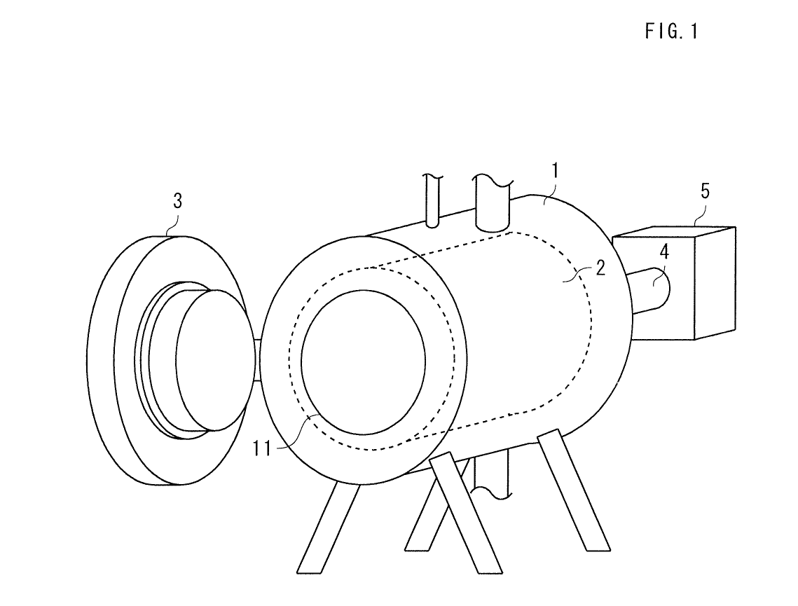

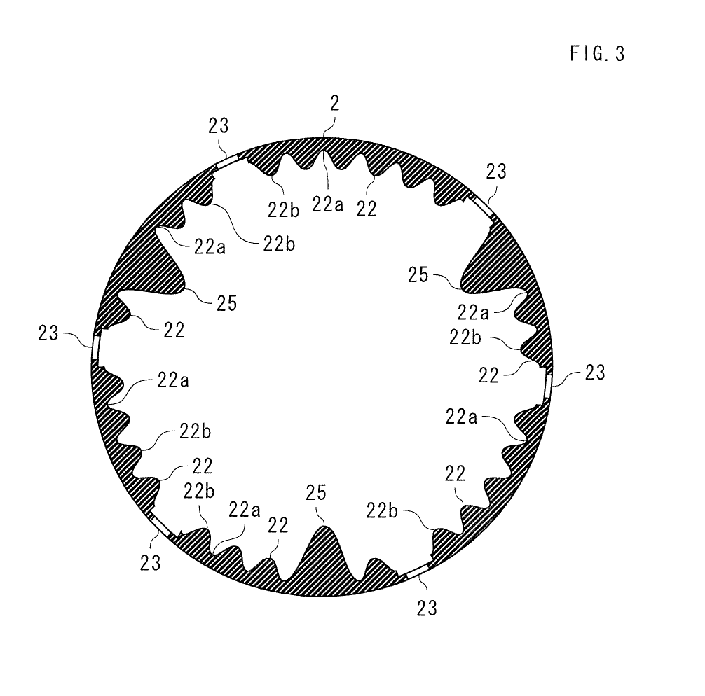

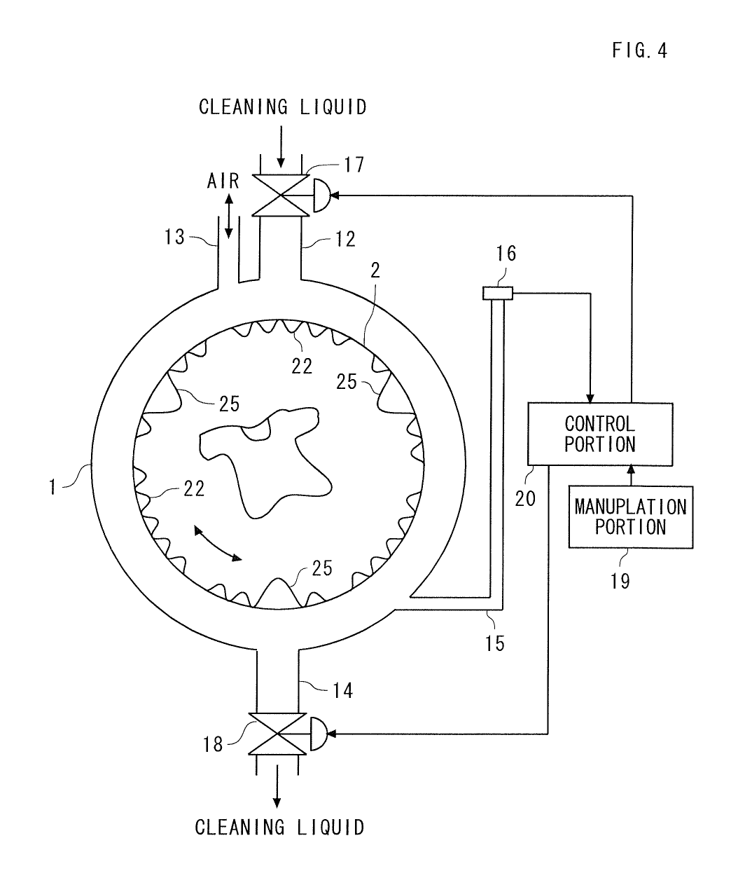

A washing apparatus in accordance with an embodiment of the present invention will be described by referring to the drawings. FIG. 1 is a schematic perspective view that shows a construction of a washing apparatus in accordance with an embodiment of the present invention, and FIG. 2 is a schematic perspective view that shows a construction of a washing tub in the washing apparatus shown in FIG. 1. Also, FIG. 3 is a schematic cross sectional view of a washing tub that is vertical to a rotating axis of the washing tub shown in FIG. 2. Furthermore, FIG. 4 is a block diagram that shows an approximate construction of a piping system and a control system of a washing apparatus in accordance with the embodiment of the present invention.

### (1) Construction of a Washing Apparatus

A washing apparatus shown in FIG. 1 is provided with a casing 1 that has a cleaning liquid supplied to the internal thereof; a washing tub 2 in a cylindrical shape that is installed to the internal of the casing 1; a door 3 that covers a port 11 for a washing article to be put in being installed by opening a front surface side of the casing 1; a rotating axis 4 that is connected to the washing tub 1, penetrating through the casing 1; and a driving mechanism 5 that rotates the washing tub 2 by transmitting a rotating force by way of the rotating axis 4. Each of the casing 1 and the washing tub 2 shown in FIG. 1 is constructed in a cylindrical form in a manner that the central axis thereof inclines from the vertical direction to the horizontal direction. Namely, the washing apparatus 2 rotates inside the casing 1 with the central axis, which is in a horizontal direction or a horizontally inclined direction, serving as the rotating axis. Additionally, the casing 1 is not limited to a cylindrical form whose cross section is concentric to the washing tub 2 but may be formed in a manner that the washing tub 2 can rotate freely inside thereof.

As shown in FIG. 1, the door 3 has a part that is provided with a protruding portion being inserted into the internal of the casing 1 through the port 11. When the port 11 is closed by the door 3, by having the protruding portion of the door 3 engaged into the port 11, the casing 1 is sealed closely by the door 3 so as not to make the cleaning liquid leak out. Also, the door 3 may be provided with a window that is made of a transparent member such as a glass, an acrylic board and the like, in order that a worker can confirm the internal of the casing 1 when the casing 1 is closed. As a result, the worker can confirm the amount of the cleaning liquid to be supplied to the internal of the casing 1, the condition of washing articles that are being washed, and the like. The driving mechanism 5 may consist of an electric motor that is equipped with a rotating axis 4, or may consist of an electric motor that indirectly rotates the rotating axis 4, and a pully and a belt that transmit the rotation of the electric motor to the rotating axis 4. In addition, since the driving mechanism 5 is installed to the outside of the casing 1, the rotating axis 4 is inserted into the casing 1 and connected to the washing tub 2. Consequently, the casing 1 is provided with a bearing portion where the rotating axis 4 is inserted. The bearing portion has a sealing structure that prevents the cleaning liquid in the casing 1 from leaking out.

The construction of the washing tub 2 in a washing apparatus that is constructed as described above will be explained by referring to FIG. 2 through FIG. 4. As shown in FIG. 2, the washing tub 2 whose rotating axis is in a horizontal direction or in a horizontally inclined direction is formed in a shape of a basket that is provided with an open surface 21 which is made in one of flat surfaces. The inside wall surface of the washing tub 2 is provided with a concave and convex curve surface 22 where the cross section being vertical to the rotating axis of the washing tub 2 has concaves and convexes that are continuous along the periphery of the washing tub; slits 23 that are opened with the direction of the rotating axis of the washing tub 2 serving as the longitudinal direction; and a baffle 25 that is supplied onto a part of the concave and convex curve surface 22. Then as shown in FIG. 3, the concave and convex curve surface 22 and the slits 23 are formed alternately along the circumferential direction on the cross section of the inside wall surface of the washing tub 2 being vertical to the rotating axis of the washing tub 2. In FIG. 2 and FIG. 4, the concave and convex curve surface 22 and the slits 23 are provided at equal spaces, while FIG. 3 shows an example in which the concave and convex curve surface 22 and the slits 23 are provided at unequal spaces.

As shown in FIG. 2 and FIG. 3, the concave and convex curve surface 22 being provided to the inside wall surface of the washing tub 2 is formed by a curve surface that makes the cross section in a concave and convex form which is vertical to the rotating axis of the washing tub 2 be continuous along the direction of the rotating axis of the washing tub 2. In other words, when the direction of the rotating axis of the washing tub 2 serves as the longitudinal direction of either a concave portion or a convex portion, the concave and convex curve surface 22 is constructed on the inside wall surface of the washing tub 2 by having concave portions 22a and convex portions 22b formed alternately in a manner that the concave portions 22a and the convex portions 22b are continuous along the periphery which is vertical to the rotating axis of the washing tub 2. In addition, since the slits 23 penetrate from the inside wall to the outside wall of the washing tub 2, the cleaning liquid inside the washing tub 2 is discharged to a region between the casing 1 and the washing tub 2 through the slits 23, and the cleaning liquid inside the region between the casing 1 and the washing tub 2 flows into the internal of the washing tub 2 through the slits 23.

In the construction shown in FIG. 2, the slits 23 are opened with the direction of the rotating axis of the washing tub 2 serving as the longitudinal direction. However, the slits 23 may be formed by a plurality number of slots that are arranged along the direction of the rotating axis of the washing tub 2. Additionally, the slits 23 may be provided not only on the inside wall surface that serves as the circumferential surface of the washing tub 2 but also on a flat surface 24 that is opposite to an open surface 21; or the slits 23 may be provided with a gap supplied between the casing 1 (See FIG. 1.) and the open surface 21. Also, the slits 23 may be provided only between the casing 1 and the open surface 21, or may be provided only on the flat surface 24. Furthermore, the construction of the washing tub 2 is not limited to a construction in which the concave and convex curve surface 22 and the slits 23 are formed alternately on the inside wall surface thereof, but the washing tub 2 may be constructed in such a manner as the concave and convex curve surface 22 is formed on the entire periphery of the inside wall surface of the washing tub 2 with the slits 23 made for a part of the concave portions 22a.

Moreover, the baffle 25 is provided between two concave portions 22a on a part of the concave and convex curve surface 22. Also, the baffle 25 is constructed so as to be protruded in a manner that the height of the baffle 25 is larger than the height of the convex portions 22b, being viewed along the radius of the washing tub 2. Then, same as the convex portions 22b, the baffle 25 is formed in a manner that the cross section protruding from the inside wall surface of the washing tub 2 to the rotating axis of the washing tub 2 is continuous along the rotating axis of the washing tub 2. A plurality number of baffles 25 may be provided on the inside wall surface of the washing tub 2, or only one baffle 25 may be provided. When a plurality number of baffles 25 are provided on the inside wall surface of the washing tub 2, it is preferable that the baffles 25 are provided at equal spaces along the circumferential direction of the washing tub 2. In FIG. 2 and FIG. 3, three baffles 25 are provided on the inside wall surface of the washing tub 2 to be convex. However, as for the amount of the baffles 25, more than one is sufficient, so that the amount of the baffles 25 is not limited to three (3).

In the washing tub 2 that is constructed as described above, for the circumferential direction of the washing tub 2, the concave portions 22a and the convex portions 22b are formed alternately on the concave and convex curve surface 22, and the baffles 25 are provided in place of the convex portions 22b. Wherein, by making the change of the form of each of the bottoms of the concave portions 22a, the crests of the convex portions 22b and the connections of the concave portions 22a to the convex portions 22b be moderate, the curve line of the circumferential cross section of the concave and convex curve surface 22 can be smooth. As a result, when the concave and convex curve surface 22 rotates along the circumferential direction of the washing tub 2, it is possible to restrain a disturbance to a flow at the time when the convex portions 22b generate the flow for the liquid in the internals of the concave portions 22a. The concave and convex curve surface 22 may be formed to have a same width along the periphery of the washing tub 2, or as shown in FIG. 3, may have a different width along the periphery of the washing tub 2. The concave and convex curve surface 22 may be made of a curved thin metal plate and installed to the inside wall surface of the washing tub 2 in a shape of a cylindrical basket that has the slits 23 supplied.

As shown in FIG. 4, in the washing apparatus in accordance with the present embodiment, the upper part of the casing 1 is provided with a liquid supply flow path 12 that supplies the cleaning liquid to the casing 1; and an air flow path 13 that sucks and discharges the air inside the casing 1; while the lower rt of the casing 1 is provided with a discharge liquid flow path 14 that discharges the cleaning liquid from the casing 1. Moreover, a level measurement piping 15 and a pressure sensor 16 are installed to the washing apparatus in accordance with the present embodiment in order to measure the level of the cleaning liquid being supplied to the internal of the casing 1. The washing apparatus in accordance with the present embodiment is also provided with a flow control valve 17 that controls the flow of the cleaning liquid being supplied from the liquid supply flow path 12; a flow control valve 18 that controls the flow of the cleaning liquid being discharged from the discharge liquid flow path 14; a manipulation portion 19 that is manipulated by a worker; and a control portion 20 that controls opening and closure of the flow control valves 17 and 18, respectively, by specifying the valve opening.

At this time, the liquid measurement piping 15 is connected to a lower position than the central axis of the washing tub 2 with respect to the casing 1 and constructed to be vertically bent. In the liquid measurement piping 15, the pressure sensor 16 that senses the pressure inside the liquid measurement piping 15 is installed to the other end thereof being opposite to the connection side thereof to the casing 1, so as to be higher than the vertically topmost point of the washing tub 2. In the liquid measurement piping 15 having the sensor 16 installed as described above, a part of the cleaning liquid being supplied to the internal of the casing 1 enters, and the vertical level of the cleaning liquid becomes as high as the level of the cleaning liquid inside the casing 1. Then, by having the pressure sensor 16 measure the pressure of the air inside the liquid measurement piping 15, the level of the cleaning liquid inside the liquid measurement piping 15 is measured, and thereby, the level of the cleaning liquid inside the casing 1 being as high as the level of the cleaning liquid inside the liquid measurement piping 15 is measured.

In the washing apparatus being constructed as described above, the control portion 20 receives a signal based on the detail of manipulation being detected by the manipulation portion 19, and also sets the valve opening of the flow control valves 17 and 18, respectively, based on a signal from the pressure sensor 16, depending on the detail of manipulation being performed by the manipulation portion 19. Namely when the worker manipulates the manipulation portion 19 so as to input the content of a washing article to be washed, the control portion 20 calculates the level of the cleaning liquid being supplied to the internal of the casing 1, based on the detail of the washing article being put into the washing tub 2. Then, in order to maintain the level of the cleaning liquid being calculated, the control portion 20 controls the valve opening of the flow control valves 17 and 18 so as to achieve optimum valve openings, based on the level of the cleaning liquid in accordance with the signal from the pressure sensor 16.

Additionally, in the washing apparatus being constructed as described above, the liquid supply flow path 12 may be provided to a region overlapping the washing tub 2 in the upper part of the casing 1, or may be provided to a location that does not overlap the washing tub 2. A plurality number of liquid flow paths 12 may be provided in parallel to the central axis of the washing tub 2, or one liquid flow path may be provided. Moreover, the liquid measurement piping 15 and the pressure sensor 16 are employed in a manner that they serve as level sensors that measure the level of the cleaning liquid inside the casing 1. However, the level sensors may be constructed in a manner that they measure the level of the cleaning liquid by measuring electrostatic capacity or electrical resistance.

Although being not illustrated, same as Patent Publication 3, a discharge liquid treatment portion that gives regeneration treatment to the cleaning liquid being discharged from the discharge liquid flow path 14 may be provided; and a pump that has the cleaning liquid, being subject to the regeneration treatment in the discharge liquid treatment portion, flow into the liquid supply flow path 12 and circulates the cleaning liquid in the casing 1 may also be provided. Additionally, same as Patent Publication 3, a water tank that temporarily stores the cleaning liquid to be supplied to the internal of the casing 1 may be provided. Moreover, same as Patent Publication 3, an air valve may be installed to the air flow path 13 so as to prevent the liquid in the internal casing 1 from leaking out; or when the above-mentioned tank is installed, the air flow path 13 may be connected to the tank.

(2) Washing Behavior in Accordance with the Spurious Zero-Gravity Wash Method

In the washing apparatus being constructed as described above, it is possible to exercise a washing behavior in accordance with the spurious zero-gravity wash method and a washing behavior in accordance with the beat wash method, by adjusting the volume of the cleaning liquid to be supplied to the cleaning tub 2. First, the washing behavior in accordance with the spurious zero-gravity wash method will be explained briefly hereinafter. When the washing apparatus being constructed as described above executes the washing behavior in accordance with the spurious zero-gravity wash method, first, the control portion 20 gives a control signal to the flow control valves 17 and 18, so as to open the flow control valve 17 and at the same time, close the flow control valve 18. Thereby, the cleaning liquid is supplied to the casing 1 by way of the liquid supply flow path 12 until the washing tub 2 containing washing articles soaks in the cleaning liquid. Then, by receiving an electrical signal from the pressure sensor 16, the control portion 20 confirms the level of the cleaning liquid in the washing tub 2, and judges whether or not such a level has attained as is set in accordance with the detail of the washing articles which is input by the manipulation portion 19.

When the washing behavior in accordance with the spurious zero-gravity wash method is executed, the level of the cleaning liquid may be set in a range between the position higher than the central axis of the washing tub 2 and the position higher than the highest point of the washing tub 2 (the height that is gained in a condition in which the washing tub 2 is filled with the cleaning liquid to the top). At this time, when execution of the washing behavior in accordance with the spurious zero-gravity wash method is specified, basically, the level of the cleaning liquid may be set in a manner that the washing tub 2 is filled with the cleaning liquid completely. Then, in a case where a large buoyant force is applied to the washing article, such as a down coat whose gravity is small and the like, for an exception, the washing tub 2 may not be thoroughly filled with the cleaning liquid by setting the level of the washing liquid low enough to have an air layer formed in the upper part of the washing tub 2.

When the control portion 20 confirms, as described above, that the level of the cleaning liquid in the washing tub 2 has attained a sufficient level for having the washing article float, the washing tub 2 begins to rotate by having the control portion 20 drive the driving mechanism 5. As a result, the washing tub 2 rotates inside the cleaning liquid in the casing 1, so that the washing article inside the washing tub 2 floats and then spreads, whereby causing the cleaning liquid to wash and rinse the washing article. In a case of rinsing, water for rinsing is supplied in place of the cleaning liquid. At this time, the control portion 2 operates a non-illustrated pump, and at the same time, circulates the cleaning liquid in the washing tub 2 by adjusting the valve opening of the flow control valves 17 and 18. Additionally, when the control portion 20 confirms that the internal of the casing 1 is filled with the cleaning liquid, the control portion 20 may close the flow control valves 17 and 18, respectively, rotate the washing tub 2 without circulating the cleaning liquid, and execute the washing behavior in accordance with the spurious zero-gravity wash method.

At this time, in the cleaning liquid filling the washing tub 2, a flow from the inside wall surface of the washing tub 22 is formed, based on the rotation of the concave and convex curve surface 22. Then, the flow of the cleaning liquid that is generated from the inside wall surface of the washing tub 22 propagates toward the rotating axis of the washing tub 2, which results in generation of a pressure distribution in the cleaning liquid inside the washing tub 2. By having the pressure distribution and the buoyant force of the cleaning liquid work on the washing article, the washing article spreads and behaves in the cleaning liquid inside the washing tub 2 in such a manner as it is floating in a non-gravity condition, and thereby, washing or rinsing is performed. Additionally, because the pressure distribution is generated in the cleaning liquid inside the washing tub 2 by having layers that are different in the flow rate formed, the washing article in the cleaning liquid behaves in a manner that it is affected by the fast flow of the cleaning liquid when the washing article moves to the inside wall surface of the washing tub 2.

In other words, in addition to a large flow in the direction of rotation, a swirling current exists that is formed by the concave and convex current surface 22 in the cleaning liquid of the washing tub 2. Therefore, due to the above-mentioned flow of the cleaning liquid, the washing article is not only prevented from hitting against the inside wall surface of the washing tub 2 but also forced to move toward the rotating axis. Additionally, because the pressure distribution is formed inside the cleaning liquid due to the difference in the flow rate of the cleaning liquid, the washing article that is affected by the flow rate of each layer drifts in the cleaning liquid and at the same time, spreads. Thereby, a face of the washing article to be in contact with liquid molecules of the cleaning liquid is enlarged, whereby washing and rinsing effects of the cleaning liquid are enhanced and also burdens of the washing article such as twist based on the flow of the cleaning liquid, impact to the washing tub 2, and the like are mitigated. As a result, damages being caused by washing are reduced.

(3) Washing Behavior in Accordance with the Beat Wash Method

Next, the washing behavior in accordance with the beat wash method will be described briefly hereinafter. Same as the spurious non-gravity wash method, the control portion 20 gives a control signal so as to open the flow control valve 17 and close the flow control valve 18; and thereby, the cleaning liquid is supplied to the internal of the casing 1 by way of the flow supply flow path 12. After that, the control portion 20 receives an electrical signal from the pressure sensor 16 and confirms that the level of the cleaning liquid inside the washing tub 2 has attained a level being set in accordance with the detail of the washing article being input by the manipulation portion 19. Then, the control portion 20 gives a control signal and closes the flow control valves 17 and 18. By driving the driving mechanism 5, the control portion 20 begins to rotate the washing tub 2.

In the behavior in accordance with the beat wash method, being compared to the washing behavior in accordance with the spurious non-gravity wash method, the level of the cleaning liquid for commencing rotation of the washing tub 2 is set to be low in such a manner as the level is set to be lower than the rotating axis of the washing tub 2, and the like. Then, in order to sufficiently attain the washing effect of the beat wash method, the level of the cleaning liquid is set to be low in the washing tub 2. On the other hand, in case of washing a washing article that is not applicable to the beat wash method, the level of the cleaning liquid in the washing tub 2 may be set to be high, and the washing article may be washed based on the effect of the hand-wash-like rubbing wash. Moreover, in the washing behavior in accordance with the beat wash method, the level of the cleaning liquid in the washing tub 2 is set at a value that corresponds to the volume (capacity or weight) of the washing articles that are put into the washing tub 2. Namely, when the amount of the washing articles being put into the washing tub 2 is large, the level of the cleaning liquid in the washing tub 2 is set to be high, but when the amount of the washing articles being put into the washing tub 2 is small, the level of the cleaning liquid is set to be low.

By having the washing tub 2 rotate as described above, washing or rinsing begins for the washing articles. At this time, because the baffles 25 protruding from the inside wall surface of the washing tub 2 rotate due to rotation of the washing tub 2, the washing articles in the lower part of the internal of the washing tub 2 are raised up to a high position by the baffles 25. Then, the washing articles being raised up to the upper part of the washing tub 2 by the baffles 25 drop to the lower part of the washing tub 2 due to the deadweight of the washing articles. As described above, by having the baffles 25 rotate, the washing articles in the washing tub 2 are agitated. At this time, when the level of the cleaning liquid in the washing tub 2 is set to be low, the washing articles being agitated hit against the inside wall surface of the washing tub 2 by dropping, and thereby, washing in accordance with the beat wash method is executed. On the other hand, when the level of the cleaning liquid in the washing tub 2 is set to be low, the washing articles are agitated in the cleaning liquid in a manner that they roll over along the inside wall surface of the internal of the washing tub 2, and thereby, washing in accordance with the hand-wash-like rubbing wash is executed.

When the washing in accordance with the beat wash is executed, because the inside wall surface of the washing tub 2 is provided with the concave and convex curve surface 22, the washing articles that drop to the inside wall surface of the washing tub 2 or roll over along the inside wall surface of the washing tub 2 hit against crests of the convex portions 22b of the concave and convex curve surface 22. Because the crest of the convex portion 22b consists of a smooth curve surface as described above, it is possible to restrain damages to the washing articles that drop to the inside wall surface of the washing tub 2 or roll over along the inside wall surface of the washing tub 2.

The baffle 25 may be formed in a manner that the washing articles are agitated at a low position of the washing tub 2, so that washing or rinsing can always be performed, attaining the effect of the hand-wash-like rubbing wash. On the other hand, the baffle 25 may be formed in a manner that the washing articles are agitated at a high position of the washing tub 2, so that washing or rinsing is always performed, attaining the effect of the beat wash method. As described above, when the washing in accordance with the beat wash method is executed, the cleaning liquid does not circulate in the washing tub 2 with the flow control valves 17 and 18 closed. However, same as the spurious non-gravity wash method, the cleaning liquid may circulate in the washing tub 2 by adjusting the valve opening of the flow control valves 17 and 18 and operating the non-illustrated pump.

In either the above-mentioned washing behavior in accordance with the spurious non-gravity wash method or the washing behavior in accordance with the beat wash method, as for the rotation of the washing tub 2 during washing and rinsing of the washing articles, it may be possible that the rotation only in one direction is performed continuously for a specified time, or it may be possible that the rotation only in one direction is performed intermittently at specified intervals. Namely, the washing tub 2 may rotate normally (or reversely) in a continuous manner for a specified time, or may alternately repeat a rotation period in which the washing tub 2 rotates normally (or reversely) and an outage period in which the washing tub 2 stops rotation, until a specified period passes by.

In addition, when the rotation of the washing tub 2 for washing and rinsing is executed intermittently, the rotation direction may change over to the opposite direction for each rotation that starts intermittently. Namely, the rotation period in which the washing tub 2 rotates and the outage period in which the washing tub 2 stops rotation may be repeated alternately until the specified period passes by; and at the same time, for each rotation period, the rotation direction of the washing tub 2 may be changed over from normal rotation to reverse rotation and vice versa. Moreover, in a case where the liquid level is low in such a case as the washing in accordance with the beat wash method, washing or rinsing based on the effect of the hand-wash-like rubbing wash may be executed by rocking the washing tub 2 in a manner that the washing articles roll over the inside wall surface of the washing tub 2, when the rotation direction is changed over.

Additionally, in the washing apparatus in which washing and rinsing are performed as described above, the cleaning liquid being supplied during washing may be either a water type cleaning liquid or a non-water type cleaning liquid. As for the water-type cleaning liquid, water or a solvent in which a surface acting agent is mixed with water, or the like is used. By using the water-type cleaning liquid, contamination of water solubility can be washed off. Also, in case of the solvent in which a surface acting agent is mixed with water, oily contamination can be washed off by having the surface acting agent react chemically. On the other hand, a petroleum type (hydrocarbon type) solvent or an organic type solvent or the like is used for the non-water type cleaning liquid. The non-water type cleaning liquid can mainly wash off oily contamination, and has a characteristic that drying capability thereof is better than that of the water type cleaning liquid.

### (4) Water Discharge Treatment

After the control portion 20 confirms that the washing behavior in accordance with either the above-mentioned spurious non-gravity wash method or the above-mentioned beat wash method is completed by measuring the degree of contamination of the cleaning liquid, the washing time and the like, the control portion 20 stops the driving mechanism 5, so as to stop the rotation of the washing tub 2 and at the same time opens the flow control valve 18. When the cleaning liquid is circulated by the non-illustrated pump, the control portion also stops the operation of the pump. As a result, the rotation of the washing tub 2 stops and the cleaning liquid in the casing 1 is discharged from the discharge liquid flow path 14, so that it is possible to take the washed washing articles out of the washing tub 2 after opening the door 3. It is preferable that the cleaning liquid to be discharged from the casing after completion of the washing behavior as described above is supplied with regeneration treatment such as filtration, chemical treatment, and the like, and then is discharged to the outside.

### (5) Setting of the Washing Behavior

The control portion 20 determines which to adopt for a washing method between the spurious non-gravity wash method and the beat wash method, by having the manipulation portion 19 manipulated so as to input the kind, the weight and the like of the washing article. At the same time, the control portion 20 may automatically set the level of the cleaning liquid. At this time, the manipulation portion 19 may be equipped with a weight sensor and the like as a part thereof. Namely, by measuring the weight of the washing article with the weight sensor, for example, the control portion 20 can automatically set the level of the cleaning liquid for washing in accordance with the beat wash method. The kind of the washing article may be input by having a worker manipulate a key and the like of the manipulation portion 19 or by having the manipulation portion 19 read the information being memorized with an IC tag or a QR code, or the like that is attached to the washing article. Moreover, the washing method and the level of the cleaning liquid may not be automatically set by the control portion 20 but may be set by having a worker manipulate the manipulation portion 19.

In addition, as described above, after the control portion 20 adopts either the spurious non-gravity wash method or the beat wash method for the washing method and controls the washing behavior supplied to the washing article by the cleaning liquid, rinsing is performed for removing the detergent in the cleaning liquid from the washing article. At this time, for example, the control portion may execute rinsing of the washing article by adopting the spurious non-gravity wash method when high effect of rinsing is asked for by manipulation of the manipulation portion 19. Or, for example, when water-saving effect is asked for by the manipulation of the manipulation portion 19, rinsing is executed for the washing article by adopting the beat wash method.

Thereby, it is possible to specify the washing method to be adopted for washing and the washing method to be adopted for rinsing individually, so that optimum washing methods for washing and rinsing, respectively, can be combined, corresponding to the kind of the washing article and the user's wish. Additionally, in order to make washing and rinsing more effective, a plurality cycles of washing and a plurality cycles of rinsing, respectively, may consist of a combination of the washing in accordance with the spurious non-gravity wash method and the washing in accordance with the beat wash method.

Then, after rinsing is performed for the washing article, dewatering may be performed for removing the water content being included in the washing article. Namely, when the water being used for rinsing is completely discharged from the casing 1 by way of the liquid discharge flow path 14 after completion of water rinsing, the control portion 20 rotates the washing tub 2 at a high speed by operating the driving mechanism 5, and due to the centrifugal force of the washing tub 2, the water content being included in the washing article is discharged to the outside of the washing tub 2 by way of the slits 23. When such dewatering treatment as described above is performed, damages to the washing article can be inhibited because the inside wall surface of the washing tub 2 is covered with the concave and convex curve surface 22 that is formed with a smooth curve surface.

### (6) Construction of the Baffle

As described above, a washing apparatus in accordance with the present embodiment is constructed to be equipped with a baffle 25, and thereby the washing apparatus in accordance with the present embodiment can select a washing method to be adopted for washing or for rinsing between the spurious non-gravity wash method and the beat wash method, by setting the level of the cleaning liquid. Examples of construction of the baffle 25 that enables selection of the washing method will be described by referring to drawings. Three examples will be given hereinafter as the example showing the construction of the baffle 25. However, the construction of the baffle 25 is not limited to the following three examples, but the baffle 25 may be constructed in a manner that the washing article can be agitated by the baffle 25 during washing in accordance with the beat wash method and that at the same time, obstructing action is inhibited during washing in accordance with the spurious non-gravity wash method.

### 1. First Example of the Construction of the Baffle

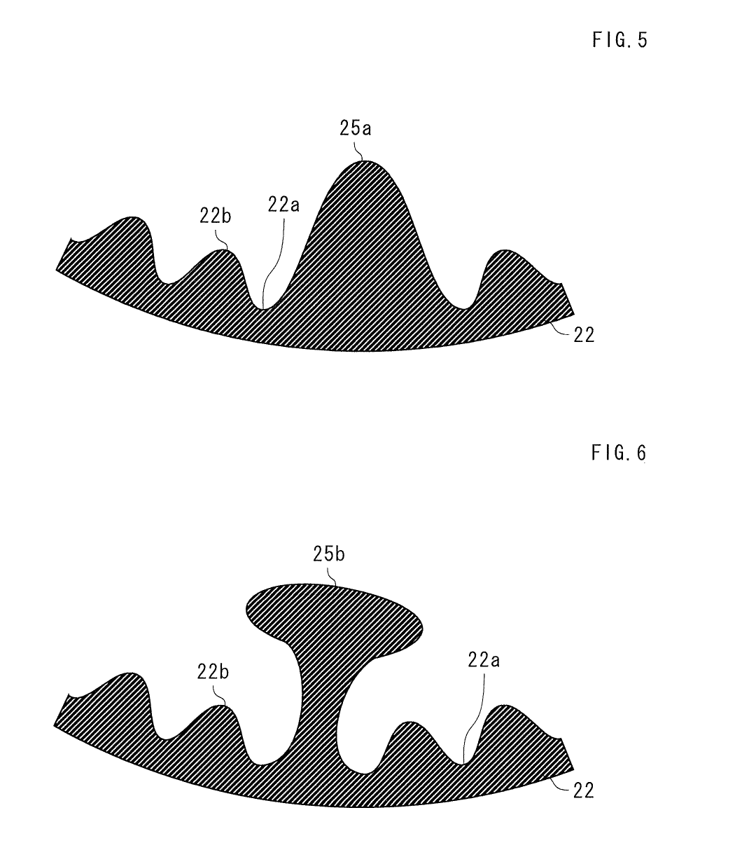

For the first example of the construction of the baffle 25 in the washing apparatus in accordance with the present embodiment, the baffle 25a is given that has such a shape of cross section as shown in a cross sectional view in FIG. 5. As shown in FIG. 5, the shape of the cross section of the baffle 25a in accordance with the present example is formed to be continuous to a concave portion 22a of the concave and convex curve surface 22, and is approximately similar to a convex portion 22b. By being constructed in such a manner as described above, the baffle 25a can be regarded as a spurious convex portion 22b on the concave and convex curve surface 22 when the washing behavior in accordance with the spurious non-gravity wash method is executed, and thereby, it is possible to have the baffle 25a act as a part of the concave and convex curve surface 22. Consequently, it is possible to inhibit the obstructing action, being caused from the protruding shape of the baffle 25a above the concave and convex curve surface 22, to a flow of the cleaning liquid that is generated while washing in accordance with the spurious non-gravity wash method. Thereby, the effect of the washing in accordance with the spurious non-gravity wash method can be achieved.

### 2. Second Example of the Construction of the Baffle

For the second example of the construction of the baffle 25 in the washing apparatus in accordance with the present embodiment, the baffle 25b is given that has such a shape of cross section as shown in a cross sectional view in FIG. 6. As shown in FIG. 6, the shape of the cross section of the baffle 25b in accordance with the present example is different from that of the baffle 25a in the above-mentioned first example, wherein the crest of the baffle 25b spreads to right and left sides (in the circumferential direction of the washing tub 2) so as to be formed to be approximately like the letter of T. It is preferable that the baffle 25b is constructed in a manner that both ends of the crest thereof are rounded in a curve line, and at the same time, it is preferable that the curvature of the outline from the connection portion to the concave and convex curve surface 22 to the crest of the baffle 25b is continuous to the curvature of the concave portion 22a, forming a smooth curve line. By having the baffle 25b constructed as described above, when the washing in accordance with the spurious non-gravity wash method is executed, an action being similar to an action working on the concave portion 22a of the concave and convex curve surface 22 works on a concave portion being constructed between the connection portion of the baffle 25b to the concave and convex curve surface 22 and the crest of the baffle 25b. At the same time, an action being similar to an action working on the convex portion 22b of the concave and convex curve surface 22 works on both ends of the crest of the baffle 25b.

Thereby, same as the baffle 25a of the first example, it is possible to inhibit the obstructing action of the baffle 25b against the flow of the cleaning liquid that is generated during washing. Additionally, because the crest of the baffle 25b is constructed in a manner that the crest thereof protrudes in the circumferential direction of the washing tub 2, it is easier to raise up the washing article, being compared to the baffle 25a of the first example, when the washing in accordance with the beat wash method is executed. Consequently, it is possible to reduce the height of the baffle 25b that protrudes in the radial direction of the washing tub 2 so as to be lower than the baffle 25a. As described above, by reducing the height of the baffle 25b that protrudes in the radial direction of the washing tub 2, it is possible to further inhibit the obstructing action being given by the baffle 25b during washing in accordance with the spurious non-gravity wash method. In the present example, the baffle 25b may have a cross section that is in a shape of a letter Y that has a concave portion supplied to the middle position of the crest of the baffle 25b.

### 3. Third Example of the Construction of the Baffle

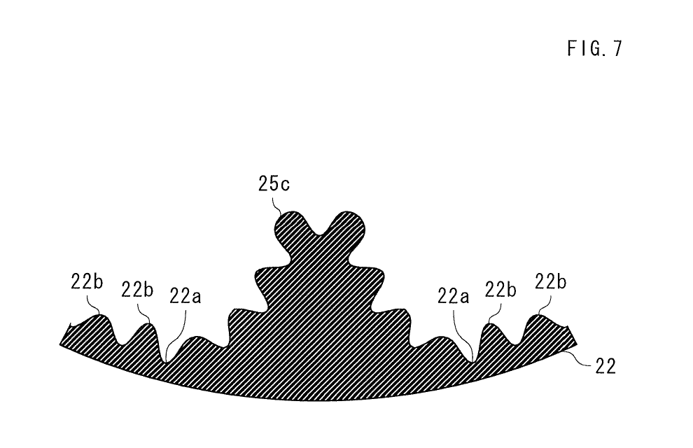

For the third example of the construction of the baffle 25 in the washing apparatus in accordance with the present embodiment, the baffle 25c is given that has such a shape of cross section as shown in a cross sectional view in FIG. 6. As shown in FIG. 7, the cross section of the baffle 25c in accordance with the present example is different from the baffle 25a in the above-mentioned first example. The cross section of the baffle 25c protrudes from the concave and convex curve surface 22 so as to be formed approximately in a shape of trapezoid, and at the same time has a surface that has the concave portion 22a and the convex portion 22b be continuous in the similar manner to the concave and convex curve surface 22. Namely, the cross section of the baffle 25c is shaped in a manner that a part of the concave and convex curve surface 22 protrudes toward the rotating axis of the washing tub 2 so as to be formed approximately in a shape of trapezoid.

Because concave portion 22a and convex portion 22b are formed for the baffle 25c in a same manner as the concave and convex curve surface 22, a flow of the cleaning liquid that is similar to a flow being generated on the concave and convex curve surface 22 is generated on the surface of the baffle 25c when the washing in accordance with the spurious non-gravity wash method is executed. Namely, a swirling current occurs along the concave portion 22a, and at the same time, a large flow of the cleaning liquid occurs along the circumferential direction of the washing tub 2. As a result, a pressure distribution is generated inside the washing tub 2, which generates a flow that has a washing article inside the cleaning liquid spread and at the same time, drift. As described above, because the surface of the baffle 25c acts, same as the concave and convex curve surface 22, the height of the baffle 25c that protrudes in the radial direction of the washing tub 2 can be increased, compared to the baffle 25a in accordance with the first example. By making the height of the baffle 25c that protrudes in the radial direction of the washing tub 2 high, in the washing in accordance with the beat wash method, it is easier for the baffle 25c to raise up the washing article, compared to the baffle 25a. Thereby, the effect of the washing in accordance with the beat wash method can be enhanced.

Additionally, in the washing apparatus in accordance with the present embodiment, the baffle 25 is installed onto the inside wall surface of the washing tub 2 so as to be fixed. However, the baffle 25 may be constructed in a manner that it can be fixed or removed from the washing tub 2. Namely, when the washing in accordance with the beat wash method is executed, by installing the baffle 25 to the inside wall surface of the washing tub 2, the washing based on agitation being caused by the baffle 25 can be executed. On the other hand, when the washing in accordance with the spurious non-gravity wash method is executed, by removing the baffle 25 from the inside wall surface of the washing tub 2, the approximately entire surface of the inside wall surface of the washing tub 2 can consist of the concave and convex surface 22, and thereby, the obstructing action being caused by the baffle 25 can be inhibited. As described above, by constructing the baffle 25 in a manner that it can either be fixed or be removed easily, the baffle 25 can be formed in an optimum shape for the washing in accordance with the beat wash method. At the same time, in the washing in accordance with the spurious non-gravity wash method, the obstructing action being caused by the baffle 25 is eliminated.

Wherein, for example, a locking member that protrudes may be provided to a portion of the baffle 25 that is closely in contact with the inside wall surface of the washing tub 2. Also, the inside wall surface of the washing tub 2 may have a locking port where a locking member is inserted. Namely, the baffle 25 may be constructed in a manner that when the washing in accordance with the beat wash method is executed, the baffle 25 is installed to the washing tub 2 by inserting the locking member of the baffle 25 into the locking port on the inside wall surface of the washing tub 2. Additionally, as for another example, the inside wall surface of the washing tub 2 may have a rail, where both ends of the baffle 25 contacting the washing tub 2 are engaged, being provided in parallel with the rotating axis of the washing tub 2. Namely, in a case where the washing in accordance with the beat wash method is executed, the baffle 25 may be installed to the washing tub 2 by having the baffle 25 engaged to the rail.

### INDUSTRIAL APPLICABILITY

The present invention can be applied to a washing apparatus that washes a washing article by rotating the washing tub thereof, which has the central axis thereof be in the horizontal direction or in the horizontally inclined direction rotate. In addition, the cleaning liquid to be used for the washing apparatus can be either water-type cleaning liquid or non-water-type cleaning liquid.

### EXPLANATIONS OF LETTERS OR NUMERALS

1 Casing
2 Washing tub
3 Door
4 Rotating axis
5 Driving mechanism
11 Port
12 Liquid supply flow path
13 Air flow path
14 Liquid discharge flow path
15 Liquid measurement piping
16 Pressure sensor
17, 18 Flow control Valve
19 Manipulation portion
20 Control portion
21 Open surface
22 Concave and convex curve surface
22a Concave portion
22b Convex portion
23 Slit
24 Flat surface
25 Baffle

1. A washing apparatus comprises:
a washing tub that rotates by a rotating axis which is inclined toward a horizontal direction from a vertical direction or is set to be horizontal and that has a washing article contained therein;
a casing that covers the washing tub and is supplied with a cleaning liquid; and
a concave and convex curve surface that is provided on an inside wall surface of the washing tub and is formed in concave and convex in radial direction of the washing tub;
wherein, at least one baffle is provided that is installed to protrude toward the radial direction of the washing tub from the inside wall surface of the washing tub; and that has a height thereof along the radial direction of the washing tub which is higher than a height of a convex portion of the concave and convex curve surface; and
wherein, a washing method of a washing article can be selected from a first washing method, in which the washing article is washed by making the washing article float in a cleaning liquid to be supplied to the washing tub, and a second washing method, in which the washing article is washed by having the baffle agitate the washing article.

2. A washing apparatus as described in claim 1,
wherein, in case of adopting the first washing method, the washing tub is rotated with a level of a cleaning liquid to be supplied to the washing tub attaining a higher position than a rotating axis of the washing tub; and
in case of adopting the second washing method, the washing tub is rotated with the level of the cleaning liquid to be supplied to the washing tub attaining a lower position than the rotating axis of the washing tub.

3. A washing apparatus as described in claim 1,
wherein the baffle can be fixed to or removed from an inside wall surface of the washing tub.

4. A washing apparatus as described in claim 1,
wherein, a shape of a cross section of the baffle that is vertical to a central axis of the washing tub is approximately similar to a shape of a cross section of a convex portion of the concave and convex curve surface.

5. A washing apparatus as described in claim 1,
wherein, a shape of a cross section of the baffle that is vertical to a central axis of the washing tub is shaped approximately in a letter of T.

6. A washing apparatus as described in claim 1,
Wherein, a surface of the baffle has a concave and convex curve surface that is approximately similar to the concave and convex curve surface.

7. A washing apparatus as described in claim 1,
wherein, the washing tub is provided with slits that penetrate from an inside wall surface thereof to an outside surface thereof.
